(19) United States
(12) Patent Application Publication
(10) Pub. No.: US 2019/0114604 A1
(43) Pub. Date: Apr. 18, 2019

(54) ADAPTIVELY INTERACTIVE KIOSKS FOR RETAIL OUTLETS

(71) Applicant: John Capogna, San Rafael, CA (US)

(72) Inventor: John Capogna, San Rafael, CA (US)

(21) Appl. No.: 16/161,001

(22) Filed: Oct. 15, 2018

Related U.S. Application Data
(60) Provisional application No. 62/572,901, filed on Oct. 16, 2017.

(51) Int. Cl. G06Q 20/18; G06F 17/30; G06K 19/07; G06K 7/10; G06Q 20/20; G06Q 30/06; G06F 3/0481

(52) U.S. Cl. CPC G06Q 20/18; G06F 17/3012; G06K 19/0723; G06K 7/10366; G06F 3/0481; G06Q 30/0631; G06Q 20/203; G06F 17/30575; G06Q 20/208

(57) ABSTRACT

An adaptively interactive kiosk for retail spaces provides consumers with the educational benefit of a digital product consultant with the pleasure of enjoying a self-guided museum tour. The interactive kiosk unique is equipped with intelligent object-recognition capabilities and an integrated point of sale system. Users can place any product from the store's display inventory onto a table, whereupon the object recognition circuitry therein identifies the product and retrieves information regarding from product information database. The user can follow clickable pathways on the user interface to learn more about the product through text, images and video, and then purchase the item on the spot. While the kiosk can be applied to any retail market, it finds particular application in retail industries in which the retail customer needs to be well-informed about the product in order to purchase intelligently.

### CROSS REFERENCE TO RELATED APPLICATIONS

This application claims benefit of U.S. provisional patent application Ser. No. 62/572,901, filed Oct. 16, 2017, which is hereby incorporated by reference in its entirety.

### BACKGROUND

### Technical Field

The present disclosure relates to systems for merchandizing. More particularly the present disclosure relates to adaptive interactive kiosks for retail outlets.

### Background Information

Certain segments of the retail sector have always recognized the importance of providing the retail customer with a positive retail experience. Purveyors of luxury goods such as couture, luxury automobiles and jewelry go out of their way to provide a pleasant buying experience: they provide luxurious seating areas for retail customers' use as they select merchandise. They often provide refreshments. And they provide a smooth, seamless point-of-sale experience. Additionally, retail customers purchasing such goods often have formidable information needs, requiring a great deal of personal attention from the sales staff as a sale proceeds. Sales staff in such venues are often highly-trained and experienced and extremely well compensated.

Increasingly, mass marketers are paying more attention to the quality of the retail experience they provide. For example, Apple Store is a chain of retail stores owned and operated by Apple, Inc. Within an Apple store, the smallest details of the retail customer experience are carefully managed. Apple has been granted design patents and received architectural awards for its stores' designs and construction, specifically for its use of glass staircases and cubes. Retail customers can get advice and help from “Creative Pros” and “Geniuses.” The enormous success of Apple Store has caused many other mass retailers to start thinking about how they can upgrade the retail customer experience.

One obstacle to providing a quality retail experience, faced by retailers in some emerging industries, is the challenge of informing and educating the consumer in a cost-effective manner while providing a pleasant, relaxing retail experience. For example, in the wine industry, it is common for a consumer to go into a wine store knowing only that he/she wants a nice bottle. They know nothing about grape varieties, countries, regions, food and wine pairings and so on. In such a case, the sales staff may spend a huge amount of time providing the retail customer with foundation information and eliciting his/her needs before the retail customer purchases a single bottle. In the meantime, a long line of people waiting to pay for their selections may have developed. Additionally, sales staff in such a setting may need to be highly-trained and experienced and may be well compensated, even though many of the transactions may amount to well under $100.00.

The emerging cannabis industry faces a similar challenge. The legalization of cannabis in several states has abruptly created a new market of millions and millions of consumers. A large portion of these new consumers lack even the most basic information necessary to purchase and use cannabis intelligently. Furthermore, there exists no way for consumers to easily inform themselves. Often, the task falls to employees in sparsely-staffed retail dispensaries. Just as in wine stores, a dispensary employee may spend a disproportionate amount of time providing a retail customer with foundation information and eliciting the retail customer's needs, all for a small purchase. In the meantime, the time the employee is giving to educating the one purchaser is being taken away from other purchasers who have made their selections and are ready to pay. Thus, the point-of-sale experience may have been degraded for a large number of purchasers while the dispensary employee was educating a single purchaser.

Additionally, a potential purchaser may avoid a cannabis retail outlet altogether because he/she may feel overwhelmed by the amount of information regarding strains and effects that he/she needs to process in order to purchase a product that satisfies his/her needs and desires.

### BRIEF DESCRIPTION OF THE DRAWINGS

FIG. 1 shows an interactive kiosk for retail spaces;

FIG. 2 provides a diagram illustrating the hardware architecture of a system incorporating the interactive kiosk of FIG. 1;

FIGS. 3A and 3B provide a diagram showing the backend relationships in the system of FIG. 2;

FIGS. 4-14 provide views of a user interface to the interactive kiosk of FIG. 1; and

FIG. 15 provides a diagram of a computing system upon which the interactive kiosk of FIG. 1 and the system of FIG. 2 may be implemented.

### SUMMARY

An interactive kiosk for retail spaces provides consumers with the educational benefit of a digital product consultant with the pleasure of enjoying a self-guided museum tour. The interactive kiosk unique is equipped with intelligent object-recognition capabilities and an integrated point of sale system. Users can place any product from the store's display inventory onto a table, whereupon the object recognition circuitry therein identifies the product and retrieves information regarding from product information database. The user can follow clickable pathways on the user interface to learn more about the product through text, images and video, and then purchase the item on the spot. While the kiosk can be applied to any retail market, it finds particular application in retail industries in which the retail customer needs to be well-informed about the product in order to purchase intelligently.

### DETAILED DESCRIPTION

An interactive kiosk for retail spaces provides consumers with the educational benefit of a digital product consultant with the pleasure of enjoying a self-guided museum tour. The interactive kiosk is equipped with intelligent object-recognition capabilities and an integrated point of sale system. Users can place any product from the store's display inventory onto a table, whereupon the object recognition circuitry therein identifies the product and retrieves information regarding from product information database. The user can follow clickable pathways on the user interface to learn more about the product through text, images and video, and then purchase the item on the spot. While the kiosk can be applied to any retail market, it finds particular application in retail industries in which the retail customer needs to be well-informed about the product in order to purchase intelligently.

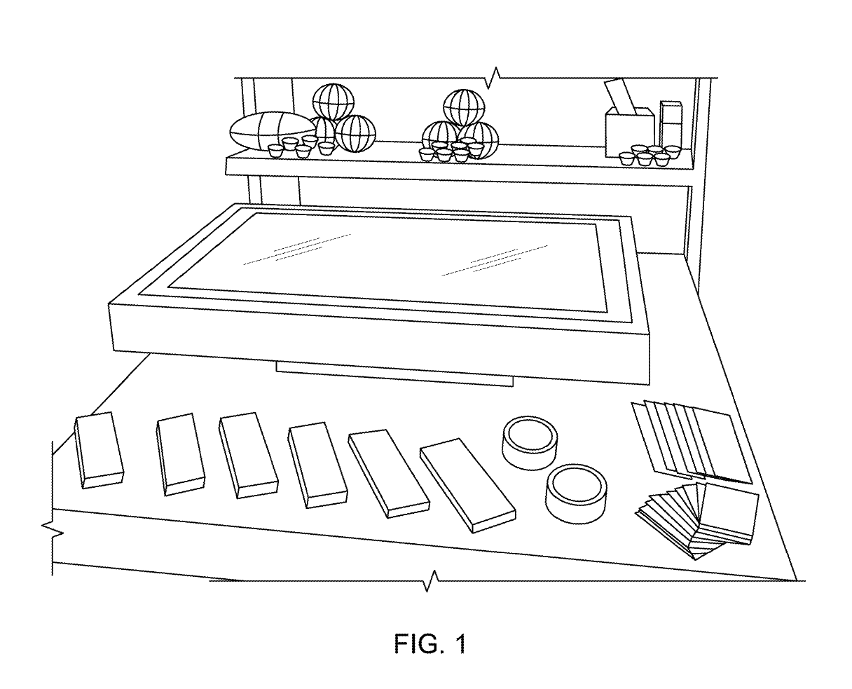

FIG. 1 shows an interactive kiosk deployed in a retail space. While the interactive kiosk finds application in nearly any sort of retail setting, it is especially useful in settings where it is desired to provide a relaxing high-touch experience in which the retail customer proceeds at his/her own pace and receives as much information as he/she needs in order to purchase intelligently without requiring the business to invest in a large, highly-trained sales staff. Some industries especially suited to the interactive kiosk are the newly-emerging cannabis industry, the microbrew industry and the wine industry. All of these are industries that benefit from educating the consumer about the products, yet the dollar amount of a typical retail purchase is relatively small.

### Hardware Relationships

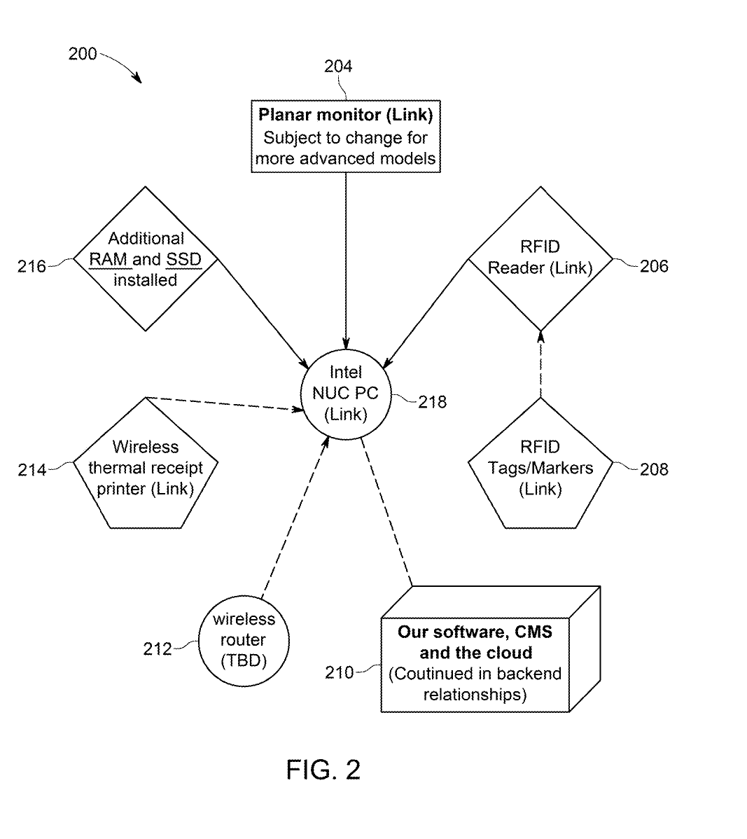

Referring now to FIG. 2, shown is a hardware architecture 200 diagram of an interactive kiosk for retail spaces.

In embodiments, the kiosk is built around an off-the shelf-barebones computer 218 such as an NUC PC (INTEL CORPORATION, Santa Clara, Calif.) that provides, for example, a motherboard, a case with fan, an external power supply and a mounting plate. Memory (RAM), a hard drive and an operating system must be provided. In embodiments, the barebones computer is then completely formatted. In embodiments, the computer may be provided with a version of the LINUX OS such as the Ubuntu distribution. In embodiments the OS installation may include custom scripts that install everything the machine needs to download and run all software packages, and boot the computer up automatically in kiosk mode whenever it's turned on.

As in FIG. 2, the kiosk further includes a multi-touch LCD display such as a PLANAR multi-touch monitor 204 (PLANAR SYSTEMS CORP, Hillsboro, Oreg.). Additionally, the kiosk includes an RFID Reader 206 such as a Parallax RFID reader (PARALLAX, Inc. Rocklin, Calif.). In embodiments, RFID tag/markers 208 may be attached to products or product packaging and may have encoded therein product descriptors.

In embodiments, the kiosk may also include a thermal receipt printer 214 and a router 212 through which the kiosk and the printer communicate to print orders.

As shown in FIG. 1, the kiosk includes a frame. In embodiments, a small fan may be mounted on the inside of the table frame.

As shown in FIG. 2, the kiosk may be equipped with a drive, such as a solid-state drive and RAM 216.

Also shown in FIG. 2, the kiosk is communicatively coupled to a remote server 210 housing the system software and a content management system (CMS). More will be said about the software and the CMS herein below.

### Kiosk Frame

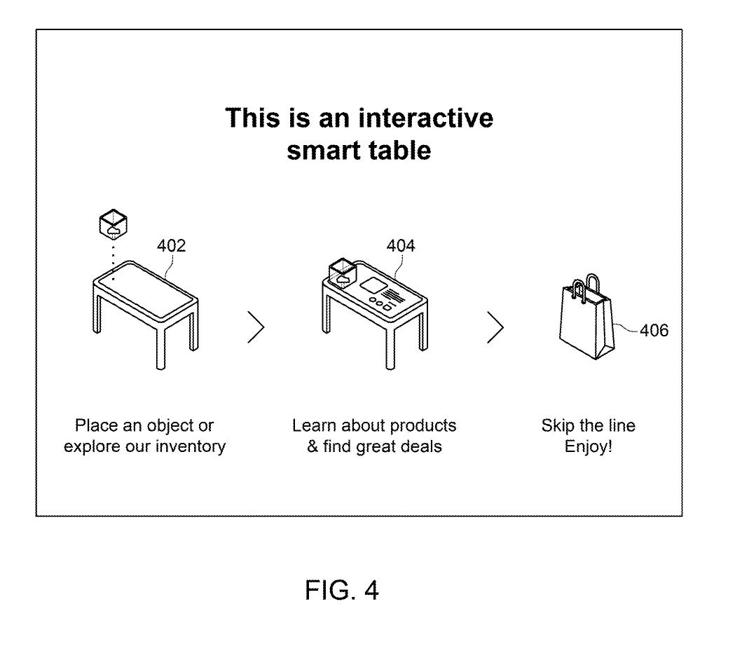

In embodiments, the display is encased within a frame, as shown in FIGS. 1 and 4. A wide variety of frames is compatible with the kiosk. In embodiments, custom shelving may be installed around the table where physical products are displayed, with RFID tags on their undersides.

### Software Relationships

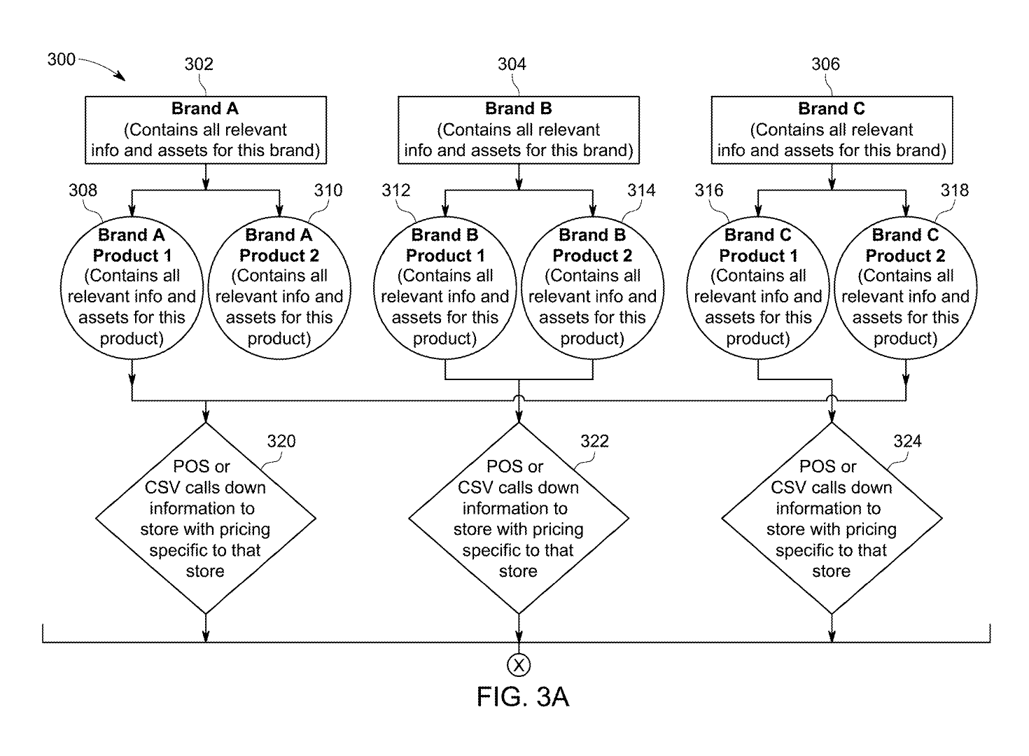

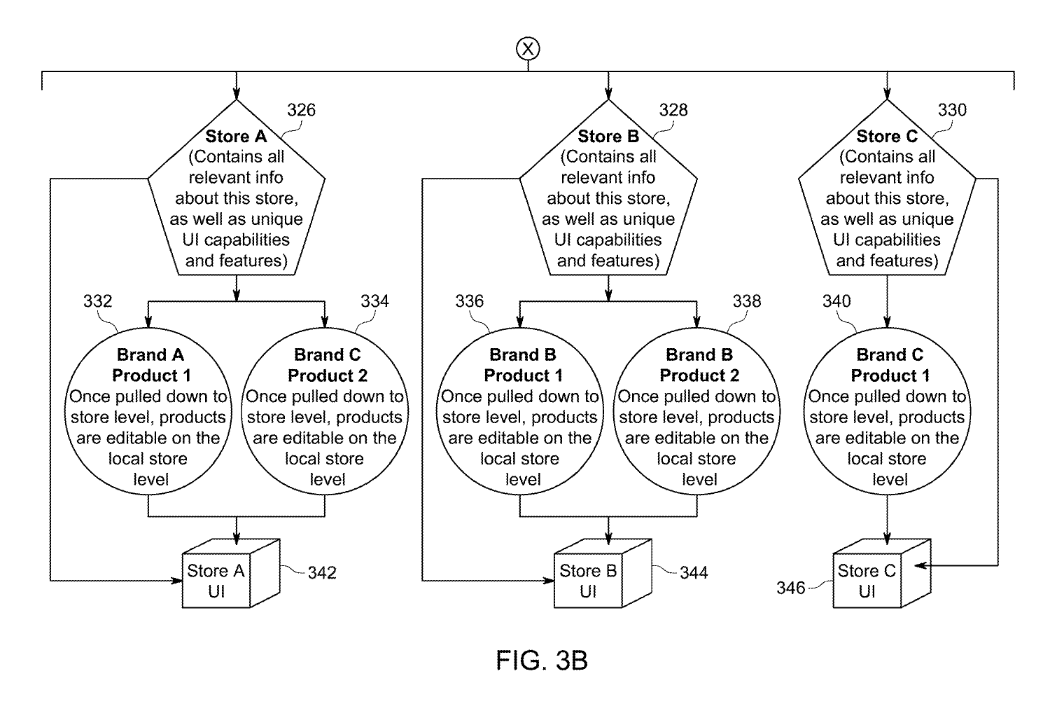

As shown in FIGS. 3A-B, the remote server houses a master database 300 that stores product metadata such as product ID, product name, etc. The content of the master database is managed via a CMS backend 210 with which new products are entered and old products are deleted, wherein each store pulls and imports products from and a system where each store has the ability to push newly created products up to the master database. Additionally, the master database specifies which products are active in each store. FIGS. 3A-B show the organization of the product metadata within the database. Product metadata is organized hierarchically, first, according to brand 302, 304, 306, and then according to products associated to each brand 308-318. In embodiments, each store may have its own SQL database with its own products 326, 328, 330.

Inventory data is first obtained from the subscriber. It should be recognized that product inventory information is obtained from the subscriber in either of two ways, as shown in FIGS. 3A-B:
by directly linking with their POS (point-of-sale) system for live updates 320-324;
when that is not available, the subscriber can provide regular inventory updates as a CSV (comma-separated values) export which can be entered into the system, to be reflected on the app display 320-324.

In the event the subscriber is using a compatible POS system, a script that connects to the subscriber's API pulls down all of the product/inventory data, which allows an up to date auto-population of products from the store's inventory onto the kiosks. Metadata tags in the master database are used by certain stores use to display certain products that are in stock. Periodically, an automatic “sync” occurs that checks for new products in store and updates inventory on the kiosk accordingly. The kiosk provides a functionality that allows retail customers to browse, look at products, add to a cart and complete a purchase, whereupon the retail customer typically goes to a point of sale such as cash register to have their order fulfilled.

In the case of a CSV subscriber, a script processes the CSV uploaded by the subscriber and then pulls down the inventory data.

Once the data is pulled down, from any source, it is modeled into a format that fits the master database, making all of the data uniform. Thus, at this point, all of the data is consistent and in the same format.

On the WordPress (WP) side of things, the first thing that happens is that the pos-sync plugin calls the JSON (JavaScript object notation) script for the inventory data. The plugin then parses out the specific data for each product and creates that product in the WP backend. This creates the first round of products. When called by the pos-sync in WP, the script queries our database for whichever subscriber and outputs all of the data the table needs in a JSON array. In this instance JSON is just a handy way to pass complex array data in a format that is easy for WP to parse.

On the next sync, new products get added, existing products get updated, and if a product is out of stock, it gets set as out of stock, or sent to draft, if the product wasn't part of the sync on the second pass. The sync also creates the list of categories for the products and puts them in their correct places.

Once the WP backend has published products 332-340, they show up on the frontend 342-346. The front end of the table works with a specific template. Basically each page is templated out in HTML/PHP/CSS and when loaded it queries the WP database to populate itself with the product data that got published in the WP Admin. The frontend talks to the backend via PHP and MYSQL to pull the data down that was saved when the products were published.

When a retail customer orders a product, a script scrapes the cart and sends that data to a thermal receipt printer, an email, or it gets pushed to the POS System API and is created as an actual order in the subscriber's POS system.

In embodiments, the front-end app running on the kiosk may be a web app, running, for example, in the CHROMIUM browser that launches in full-screen kiosk mode. The touchscreen reads clicks as people interact with the app. Customers approach the table and initially see the front end, shown in detail in FIGS. 4-12.

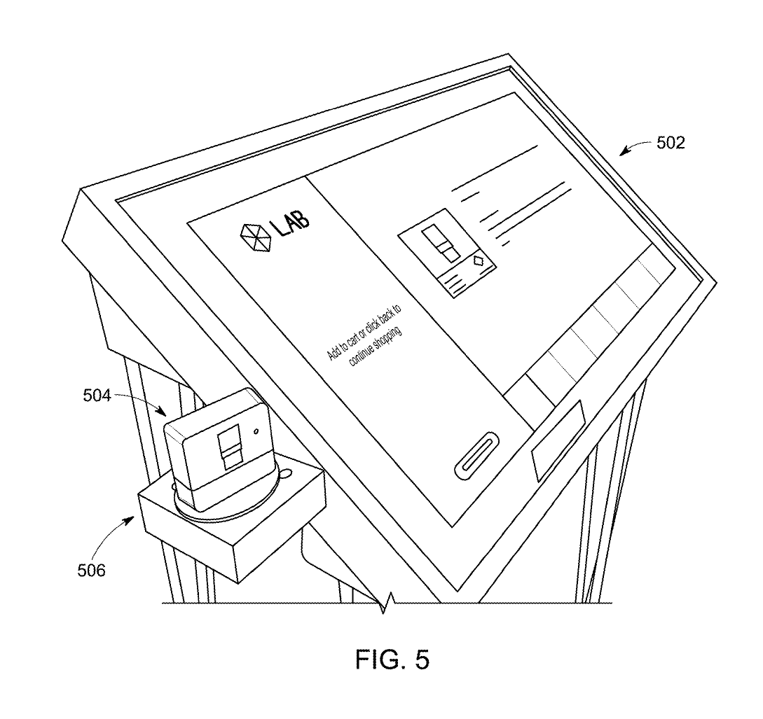

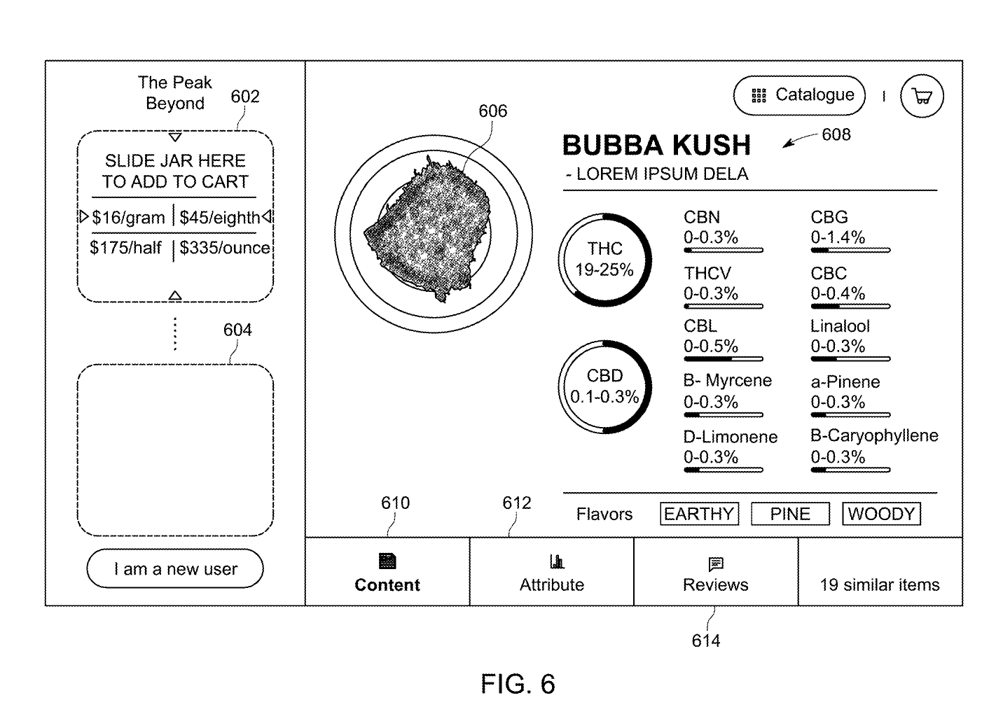

As shown in FIG. 5, When customers place a product 504 having an RFID tag attached upon or near the RFID reader 506 associated with the kiosk 502, the software recognizes the marker ID and displays product information 404. Associations between marker IDs and individual products are configured by means of the backend. In the embodiment of FIG. 5, the RFID reader may be contained within an enclosure upon which the customer sets the product in order to display product information. In other embodiments, In the RFID reader may be embedded inside the, as shown in FIGS. 6-10.

An alternative method for object recognition is via a process that reads capacitive patterns on the underside of products as touch points, to identify products and display relevant information.

An online network of hosted subdomains contains the data for each store. At the end of the day, local tables in the store run an automatic sync which pulls any new, latest, files from the server to ensure it all stays up-to-date. This makes sure that any changes made during the day are reflected locally on the kiosks after hours.

For certain stores, the POS system does not have an open API or a way to add items to cart. In these cases, the software sends a customer's order to a printer, where it prints out at the back of the house and where customers can go to pick it up 406.

The kiosk also includes the functionality of sending a text message to the customer when their order is ready to be picked up.

In embodiments, product information displayed to customers is provided by a third party, such as POTGUIDE or WIKILEAF using their APIs.

FIG. 4 provides a screenshot of a ‘welcome’ page from the frontend.

FIG. 6 provides a screenshot of a page that displays information about the content of a product 606, 608 and also shows a second user interface object 602 within which the user places a product in order to initiate a purchase transaction.

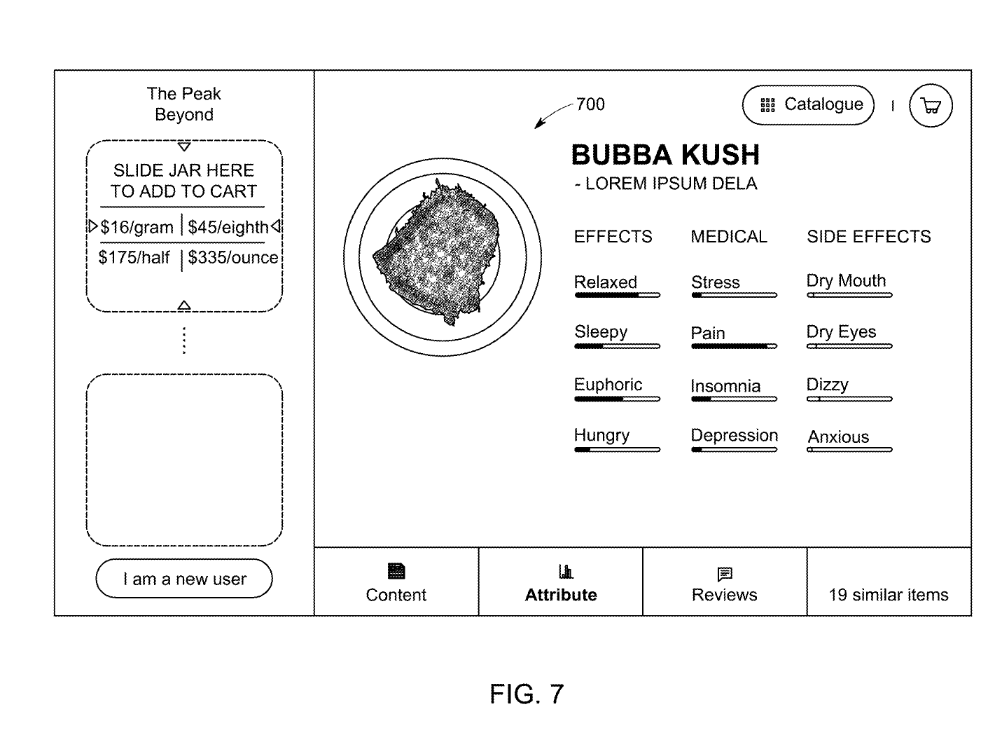

FIG. 7 provides a screenshot 700 of a page that displays information about the attributes of a product.

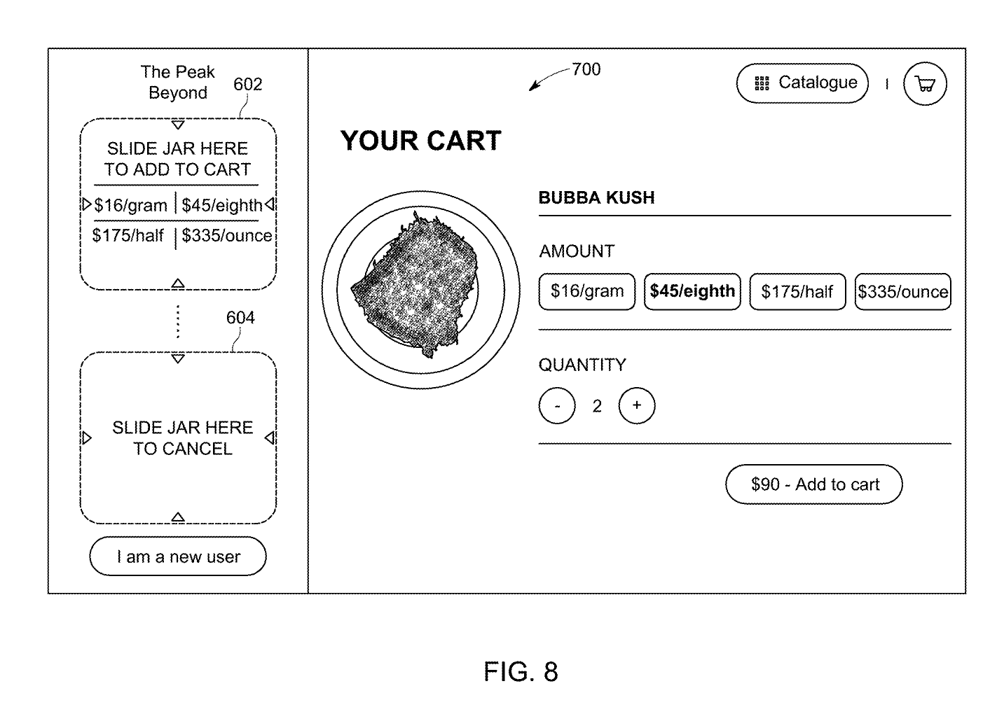

FIG. 8 provides a screenshot of a shopping cart with user interface element 602, 604 for selecting a product and initiating/cancelling a sale.

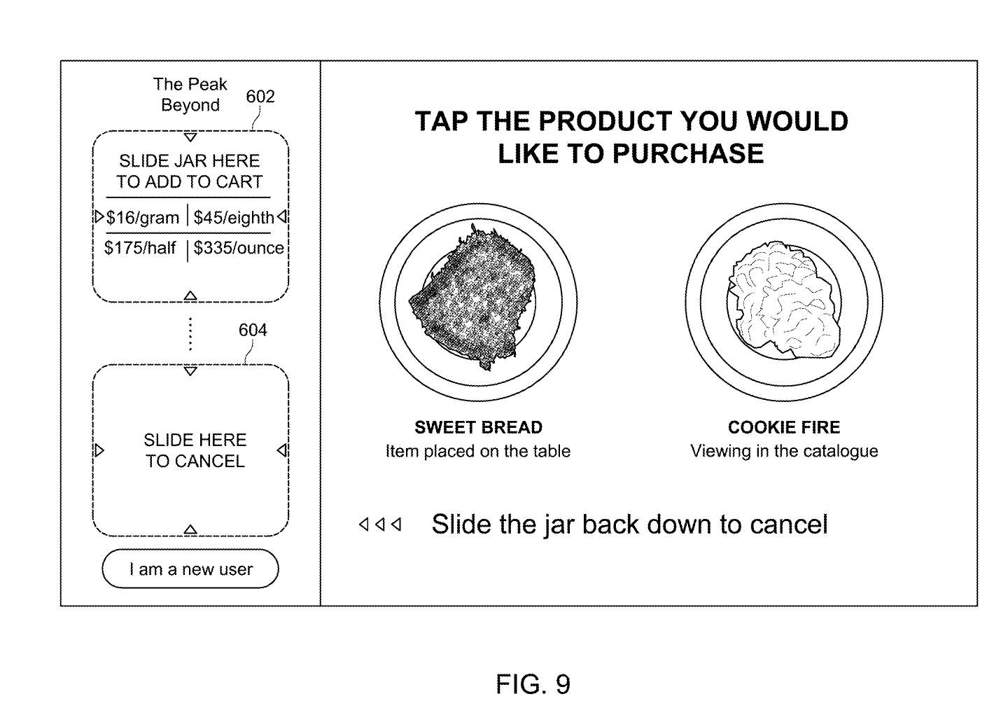

FIG. 9 provides a screenshot of a shopping cart containing products, in which the user may cancel a purchase by sliding the product container from the second user interface object 604 to the first user interface object 602.

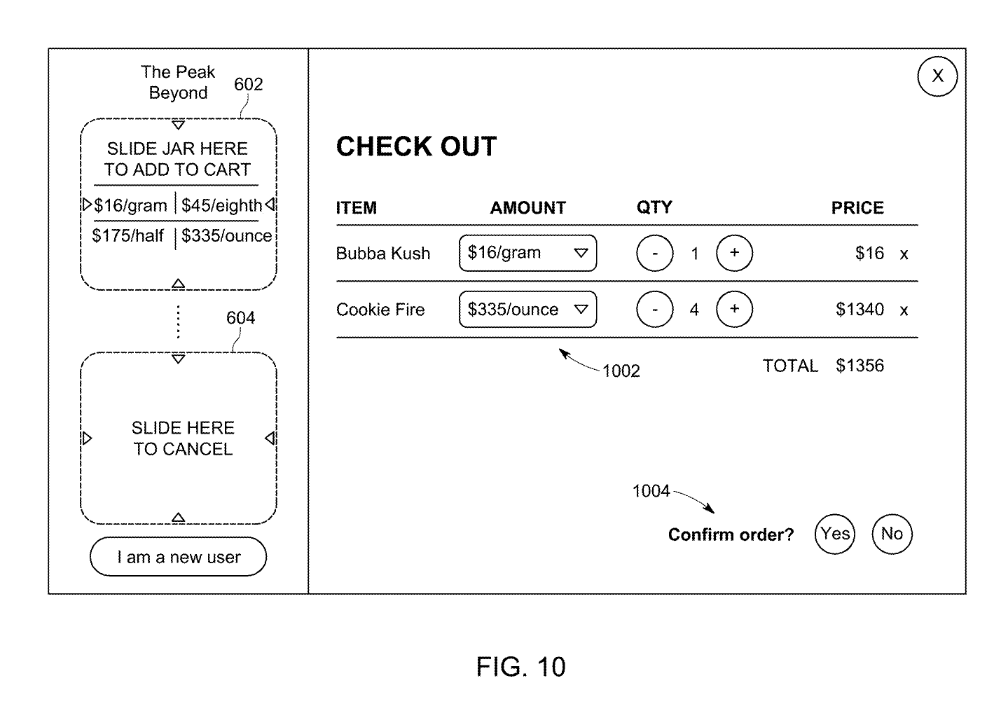

FIG. 10 provides a screenshot of a checkout page with user interface elements 602, 604 for selecting a product and cancelling a sale. Additionally, the checkout page displays transaction details 1002 and a UI element 1004 for confirming order information or editing.

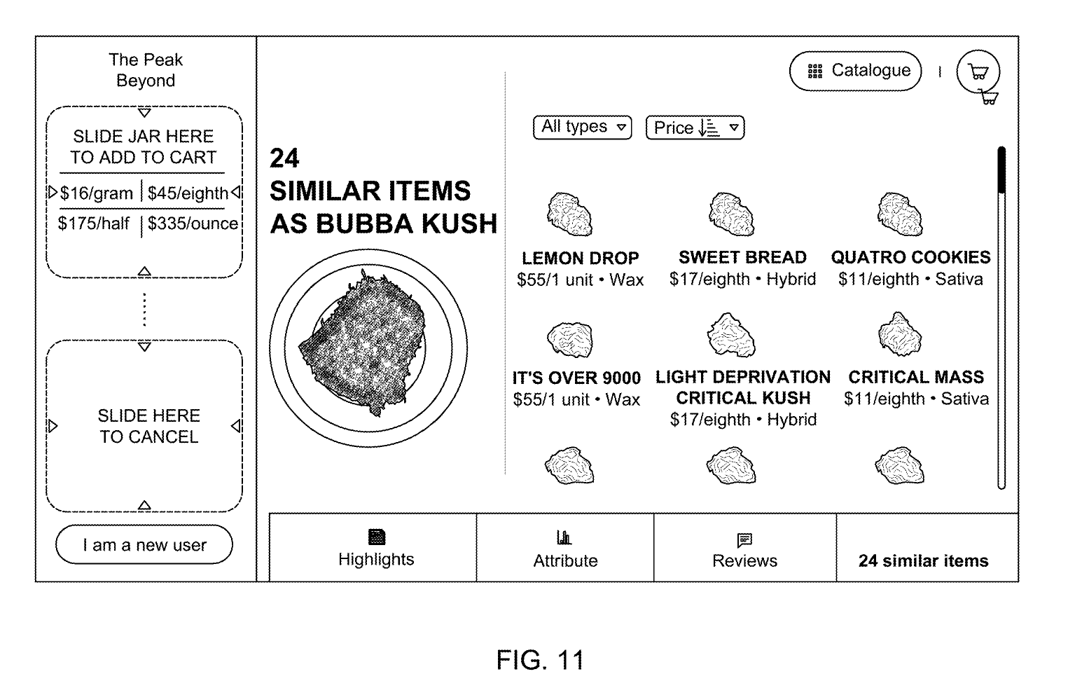

FIG. 11 provides a screenshot of a page containing information about suggestions for additional/alternate purchases.

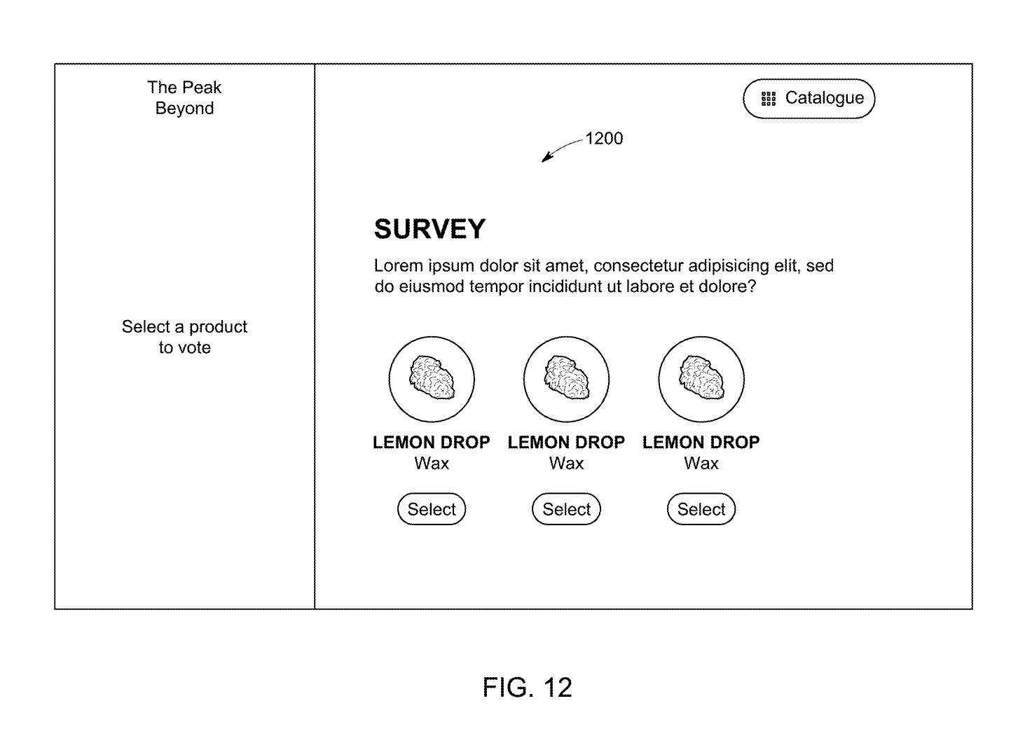

FIG. 12 provides a screenshot of a product survey page 1200.

Retail customers interacting with the kiosk enter information about what they are looking for, what effect they would like to achieve, the price point they're looking for, the flavors they want, and so on and the system sorts through a large database of information about products to make recommendations that meet the desires of the retail customer.

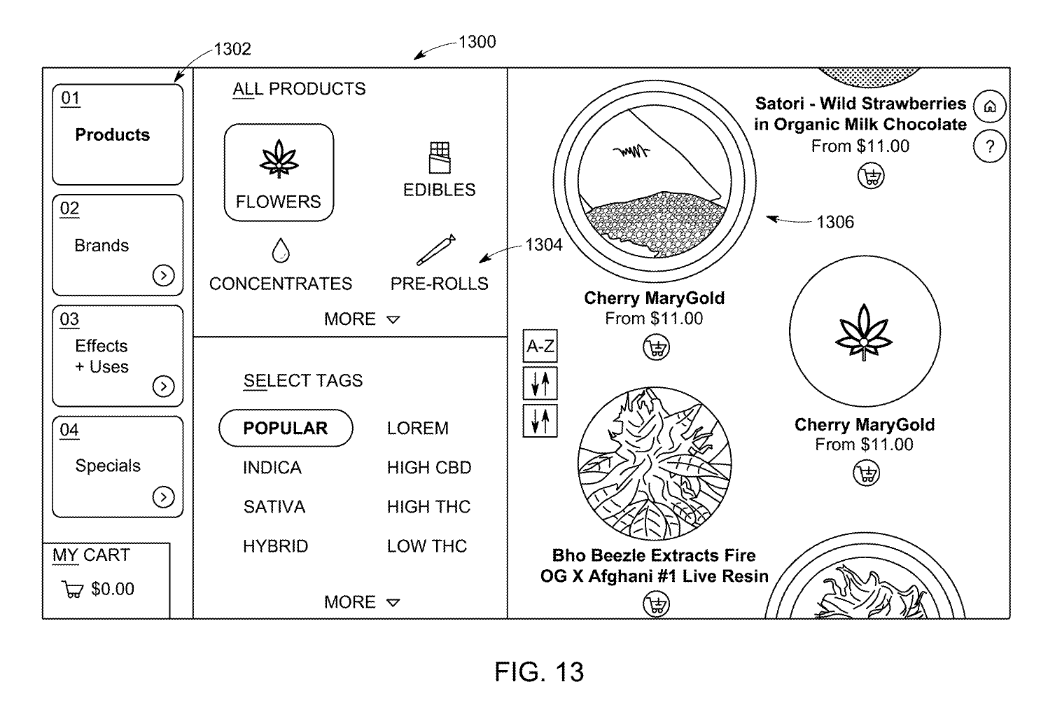

FIG. 13 shows a screenshot of a UI 1300 for live filtration of product information. By default, the UI 1300 displays information for all products available at a particular retail location. By interacting with the various features of the UI 1300, the retail customer may filter product selection by applying filters 1302, 1304 until only those products the customer is most interested are displayed 1306. Using the UI 1300, the retail customer may filter according to brand, effects & uses, specials, product type, concentration of predetermined components such as CBD and THC, product strain—for example indica or sativa and so on.

In embodiments filters may be applied in any order selected by the customer. As filters are applied, the UI display of products 1306 changes in response to the applied filter or filters.

In embodiments, certain of the filters may be mutually exclusive, in which case, the kiosk does not permit application of the two mutually-exclusive filters.

It may also be possible that application of a number of filters at the same time would return an empty set of results, in which case the product display is blank.

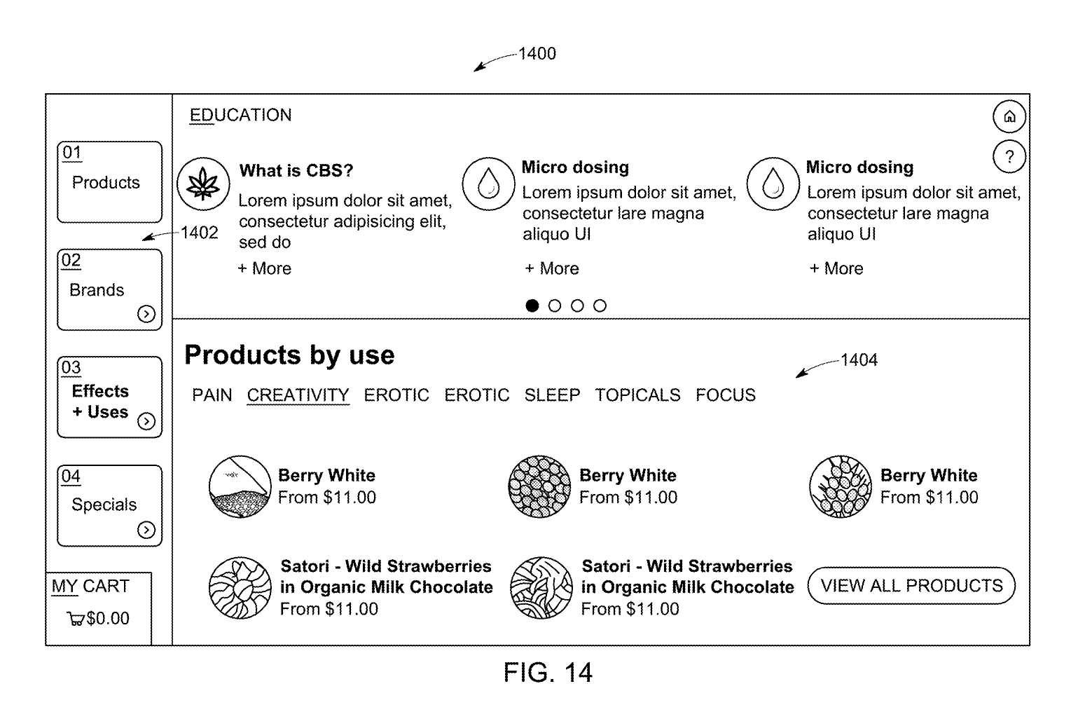

FIG. 14 shows a screenshot of an education and uses UI 1400. As previously indicated, the product display may be filtered based on intended use 1402, 1404. Interaction with this particular set of filters, will produce a display of products filtered based on intended use. Also from this page 1400, the retail customer may activate links to information provided by third parties regarding their products and their intended uses. In embodiments, for example, the third-party information may be sourced from scholarly provider such as GOOGLE SCHOLAR or MEDLINE. In embodiments, the third-party information may be sourced from other providers such as WIKILEAF and POTGUIDE.

It is to be appreciated that, as the retail customer interacts with the Kiosk, the platform adaptively learns what they want, and then makes intelligent recommendations in an manner.

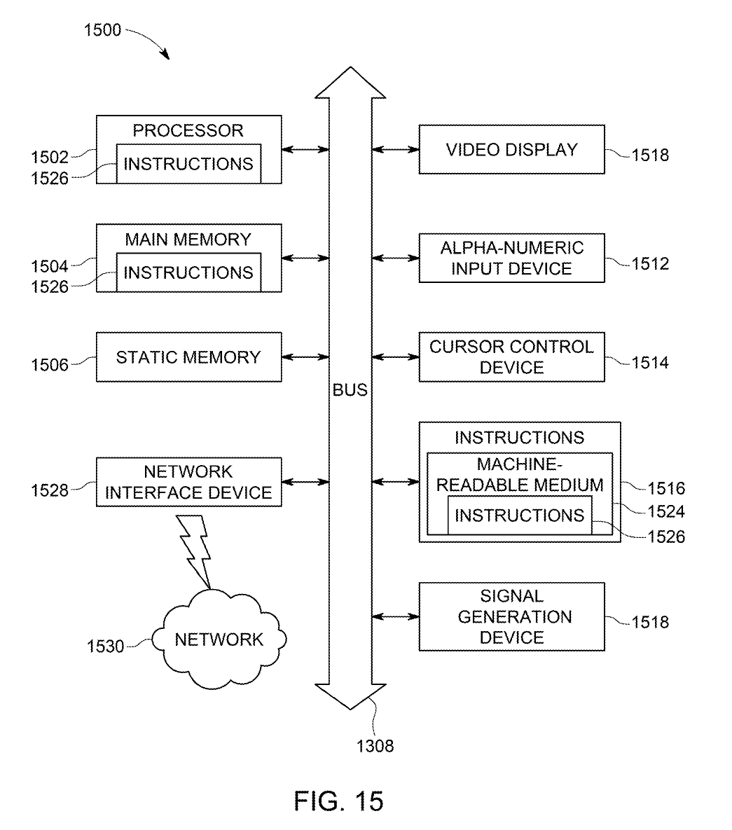

Referring now to FIG. 15, shown is a diagrammatic representation of a machine in the exemplary form of a computer system 150000 within which a set of instructions for causing the machine to perform any one of the methodologies discussed herein may be executed. In alternative embodiments, the machine may comprise a network router, a network switch, a network bridge, personal digital assistant (PDA), a cellular telephone, a web appliance or any machine capable of executing a sequence of instructions that specify actions to be taken by that machine.

The computer system 1500 includes a processor 1502, a main memory 1504 and a static memory 1506, which communicate with each other via a bus 1508. The computer system 1500 may further include a display unit 1510, for example, a liquid crystal displays (LCD) or a cathode ray tube (CRT). The computer system 1500 also includes an alphanumeric input device 1512, for example, a keyboard; a cursor control device 1514, for example, a mouse; a disk drive unit 1510, a signal generation device 1518, for example, a speaker, and a network interface device 1528

The disk drive unit 1516 includes a non-transitory machine-readable medium 1524 on which is stored a set of executable instructions, i.e. software, 1526 embodying any one, or all, of the methodologies described herein. The software 1526 is also shown to reside, completely or at least partially, within the main memory 1504 and/or within the processor 1502. The software 1526 may further be transmitted or received over a network 1530 by means of a network interface device 1528.

In contrast to the system 1500 discussed above, a different embodiment uses logic circuitry instead of computer-executed instructions to implement processing the various methodologies herein described. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large scale integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments of this invention may be used as or to support software programs executed upon some form of processing core (such as the Central Processing Unit of a computer) or otherwise implemented or realized upon or within a machine or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

1. An adaptively interactive kiosk having a graphical user interface that is triggered by physical proximity of a tangible object comprising:
a terminal having a touchscreen viewing surface;
a sensor communicatively coupled to said terminal;
a processor;
a memory containing computer-readable instructions therein which, when executed by said processor perform steps of:
receiving input data generated as a result of the user placing a tangible object having encoded thereon a product descriptor for a product represented by the tangible object within proximity of the sensor;
reading the input data;
querying a table of product descriptors;
as a result of locating a product descriptor in said table of product descriptors that corresponds to the received input data, retrieving product information from a database of product information that corresponds to the located product descriptor;
as a result of input data provided by the user touching the viewing surface, outputting at least a portion of the retrieved product information;
responsive to evaluating the input data provided by the user touching the viewing surface, displaying product information for additional suggested products,
as a result of detecting and reading input initiating a procurement transaction provided by the user touching the display, completing a procurement transaction for a selected product; and
outputting a record of the procurement transaction.

2. The interactive kiosk of claim 1, wherein the system further provides inventory information.

3. The interactive kiosk of claim 1, wherein said inventory information is contained in a master database residing on a remote server, the database including metatags that allow retailers to display products that are in stock.

4. The interactive kiosk of claim 1, further comprising a backend for:
entering products into the master database; and
selecting which products are active in each store.

5. The interactive kiosk of claim 4, wherein an automatic sync occurs at regular intervals to check for new products in a store and wherein inventory on the kiosk is updated accordingly.

6. The interactive kiosk of claim 4, wherein said remote server is communicatively coupled to said kiosk by means of a wireless connection.

7. The interactive kiosk of claim 1, further comprising a network of interactive kiosks comprising:
at least one interactive kiosk; and
at least one remote server to which each of said at least one interactive kiosk is linked;
the server housing a master database of inventory information containing inventory information for each physical location within the system;
the system further comprising a subscriber backend application that stores product information for upload to the master database, selecting which products are active at each retail location, interacts with a frontend application, telling it what to display and how to display it and interacts with third-party APIs.

8. The interactive kiosk of claim 7 wherein an automatic sync occurs at regular intervals to check for new products in a retail store and wherein inventory on the kiosk is updated accordingly.

9. The interactive kiosk of claim 7, wherein said third-parties comprises providers of product information.

10. The interactive kiosk of claim 1, wherein said tangible object comprises one of:
an actual product;
a simulation of an actual product for situations in which direct handling of an actual product by a retail customer is not permitted.

11. The interactive kiosk of claim 1, further comprising a user interface element indicating a position of the sensor.

12. The interactive kiosk of claim 1, further comprising at least one radio frequency identification (RFID) tag affixed to the tangible object, wherein the input data generated as a result of the user placing the product upon the user interface comprises a RFID code emitted by the RFID tag, wherein an RFID code emitted by the RFID tag is associated to the product descriptor for that product.

13. The interactive kiosk of claim 12, wherein said sensor comprises an RFID code reader that receives the RFID code emitted by the RFID tag.

14. The interactive kiosk of claim 1, further comprising a circuit programmed to read capacitive patterns on a surface of tangible objects as touch points in order to identify products and display relevant information.

15. The interactive kiosk of claim 1, wherein the product information comprises multimedia data that include text, image and/or video descriptions of a recognized product.

16. The interactive kiosk of claim 1, wherein the computer-readable instructions implement an interactive user interface on said touchscreen display that allows a retail customer to browse, look at products, add to a cart to complete a purchase and complete a purchase.

17. The interactive kiosk of claim 16, wherein the user interface comprises a web app that configured to run in full screen kiosk mode; and
wherein the touchscreen reads clicks as people interact with the app.

18. The interactive kiosk of claim 1, further comprising computer-readable code for sending a text message to a retail customer's mobile device when his/her order is ready to be picked up.

19. An input/output system for an interactive kiosk comprising:
a tangible object having encoded thereon a product descriptor for the product represented by the product token;
a touchscreen viewing surface;
a detecting sensor for detecting user interaction with the tangible object and capturing the encoded product descriptor when the user brings the tangible object token into close proximity with the sensor; and
a memory containing computer-readable instructions executable by a processor for:
implementing on said viewing surface a graphical user interface (GUI) for displaying product information;
triggering modification of the GUI as a result of the sensor detecting the tangible in close proximity;
triggering further modification of the GUI display responsive to the tangible object token being no longer in close proximity;
displaying product information corresponding to the product descriptor encoded on the detected tangible object; and
accepting user input provided via the touchscreen viewing surface.

20. A method of operating an adaptively interactive kiosk comprising:
receiving input data generated as a result of a user placing a tangible object within proximity of a sensor communicatively coupled with a terminal housing the interactive kiosk;
reading the input data;
querying a table of product descriptors;
as a result of locating a product descriptor in said table of product descriptors that corresponds to the received input data, retrieving product information from a database of product information that corresponds to the located product descriptor;
as a result of input data provided by the user touching the viewing surface, outputting at least a portion of the retrieved product information;
as a result of detecting and reading input initiating a procurement transaction provided by the user touching the display, completing a procurement transaction for a selected product; and
outputting a record of the procurement transaction.
